(19) United States
(12) Patent Application Publication
(10) Pub. No.: US 2026/0300929 A1
(43) Pub. Date: Oct. 1, 2026

(54) GENERATING SCHEDULE ENTRIES FOR COLLABORATIVE EVENTS UTILIZING A MULTIMODAL OBJECT SYNCHRONIZATION MODEL

(71) Applicant: Dropbox, Inc., San Francisco, CA (US)

(72) Inventors: Patrick Lightbody, Portland, OR (US); Christopher Kessel, Eugene, OR (US); Gregory Unrein, Portland, OR (US)

(21) Appl. No.: 19/191,896

(22) Filed: Apr. 28, 2025

Related U.S. Application Data
(60) Provisional application No. 63/779,726, filed on Mar. 28, 2025.

(51) Int. Cl. G06Q 10/1093

(52) U.S. Cl. CPC G06Q 10/1093

(57) ABSTRACT

The present disclosure relates to systems, non-transitory computer-readable media, and methods for generating schedule entries for collaborative events and/or focus time allocations utilizing a multimodal object synchronization model. In one or more embodiments, the disclosed systems receive a request to schedule a collaborative event with multiple candidate participants within a specified time frame. In response, the disclosed systems can generate a proposed calendar entry for the collaborative event based on one or more of: attendance priority classifications for the candidate participants, corresponding event priority scores for scheduled events identified on user-specific calendars of the candidate participants, or an event priority score for the collaborative event. In some cases, the disclosed systems further consider user preferences and historical data to generate the proposed calendar entry.

### CROSS-REFERENCE TO RELATED APPLICATIONS

This application claims priority to and the benefit of U.S. Provisional Patent Application No. 63/779,726, filed on Mar. 28, 2025, which is incorporated herein by reference in its entirety.

### BACKGROUND

Recent years have seen significant developments in digital scheduling platforms. Indeed, the increase of online scheduling activity has led to users employing several scheduling platforms and remote collaboration technologies to coordinate collaborative work efforts in both physical and virtual landscapes. To deal with the increased popularity, some conventional systems try to connect or unite different scheduling platforms for user accounts. Indeed, organizations are frequently compelled to work within a technological space in an attempt to coordinate efforts between several users across a variety of scheduling platforms and other related third-party applications with different protocols, application programming interfaces (APIs), and security structures.

Furthermore, this increase in online activity and remote collaboration often leads to several actors and/or agents initiating, modifying, and coordinating digital schedule instances that affect multiple user accounts across various applications. When scheduling a collaborative event across multiple calendars, for instance, many existing platforms require numerous user interactions from multiple affected users to propose and confirm a scheduled event while satisfying the needs and preferences of all the users involved. Further, while digital scheduling assistance are available to aid in coordinating multiple schedules, such existing technologies comprise a number of drawbacks. Many existing digital scheduling technologies, for example, can enter an infinite or near-infinite loop of scheduling and rescheduling meetings in an attempt to automatically coordinate events across multiple user accounts.

Moreover, many digital scheduling platforms are further impeded in their ability to optimally coordinate events across multiple users'schedules at least in part due to the data security safeguards in place to protect each individual user's information. Indeed, existing digital scheduling platforms face numerous impediments to efficiency when scheduling collaborative efforts and other events in the current digital landscape of remote professional work and collaborative planning.

In addition to these issues, conventional systems face further problems and issues with regard to scheduling platforms and third-party applications that share similar functions.

### SUMMARY

Embodiments of the present disclosure provide benefits and/or solve one or more of the foregoing or other problems in the art with systems, non-transitory computer readable media, and methods for generating schedule entries for collaborative events and/or focus time allocations utilizing a multimodal object synchronization model. For instance, the disclosed systems can organize collaborative events having a plurality of attendees based on various considerations. When scheduling a collaborative event, for example, the disclosed systems can intelligently determine an optimal proposed event date and time based on a variety of factors including relative priority classifications and/or scores for candidate attendees, scheduled events extracted from user-specific calendars associated with the candidate attendees, organizational and user-specific preferences, historical data related to prior collaborative events, and so forth.

Further, the disclosed systems can allocate focus time on a target user's schedule according to user preferences and in consideration of existing scheduled events from an online calendar associated with the target user. In some embodiments, for instance, the disclosed systems identify one or more scheduled events from the target user's online calendar as qualified focus time events, designates the qualified focus time events as a qualified focus time allocation toward the user's target focus time allocation, and generates schedule entries for scheduled focus time on the online calendar. Also, in some embodiments, the disclosed systems limit scheduling of events not qualified as focus time during remaining work hours in order to ensure the target focus time allocation can be reached.

Additional features and advantages of one or more embodiments of the present disclosure are outlined in the description that follows and, in part, will be obvious from the description or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an example overview of an event synchronization system generating a proposed calendar entry for a requested collaborative event in accordance with one or more embodiments.

FIG. 2 illustrates an event synchronization system utilizing a multimodal object synchronization model to generate a proposed calendar entry in accordance with one or more embodiments.

FIG. 3 illustrates an event synchronization system proposing and implementing calendar entries in accordance with one or more embodiments.

FIG. 4 illustrates an event synchronization system generating proposed calendar entries for a recurrent series of collaborative events in accordance with one or more embodiments.

FIG. 5 illustrates an example flowchart of a series of acts for generating a proposed calendar entry for a requested collaborative event in accordance with one or more embodiments.

FIG. 6 illustrates an example overview of the event synchronization system generating a proposed focus plan for a target focus time allocation in accordance with one or more embodiments.

FIG. 7 illustrates the event synchronization system identifying qualified focus time events and determining allocated focus time in accordance with one or more embodiments.

FIG. 8 illustrates an exemplary user interface for interacting with the event synchronization system in accordance with one or more embodiments.

FIG. 9 illustrates an example flowchart of a series of acts for generating a proposed calendar entry for a target focus time allocation in accordance with one or more embodiments.

FIG. 10 illustrates a diagram of an environment in which an event synchronization system can operate in accordance with one or more embodiments.

FIG. 11 illustrates an example environment of a networking system having the event synchronization system in accordance with one or more embodiments.

FIG. 12 illustrates a block diagram of an exemplary computing device in accordance with one or more embodiments.

### DETAILED DESCRIPTION

This disclosure describes one or more embodiments of an event synchronization system that intelligently generates schedule entries for collaborative events and focus time allocations utilizing a multimodal object synchronization model. For instance, the event synchronization system can intelligently organize collaborative events across multiple users and respective user-specific calendars based on a variety of considerations in an automated or partially automated manner (e.g., with some user selection of proposed calendar entries). In some embodiments, for example, the event synchronization system generates a proposed calendar entry for a requested collaborative event based on one or more of: attendance priority classifications for candidate participants of the requested collaborative event, event priority scores for scheduled events extracted from user-specific calendars associated with the candidate participants, an event priority score for the requested collaborative event, or organizational and/or user-specific preferences.

In addition or alternative to generating proposed calendar entries for requested collaborative events, the event synchronization system can intelligently allocate a target amount of focus time for a target user account utilizing a multimodal object synchronization model to manage calendar entries of an online calendar associated with the target user in an automated or partially automated manner (e.g., with some user selection of proposed calendar entries). In one or more embodiments, for example, the event synchronization system determines a target focus time allocation for a target user account, identifies one or more scheduled events on an online calendar associated with the target user account as qualified focus time events, and generates a proposed focus plan and/or a proposed calendar entry for scheduled focus time on the online calendar associated with a target user account based on the target focus time allocation and a qualified focus time allocation determined from the one or more qualified focus time events.

As mentioned, the event synchronization system provides a number of advantages over conventional digital scheduling systems. For example, the event synchronization system provides improved accuracy, flexibility, and efficiency over existing systems. As indicated above, the increased popularity of online collaborative events and digital management of work schedules has led to users employing multiple calendaring platforms. As a result, users (or agents) often do not see scheduling conflicts, have reduced visibility of events, have difficulty coordinating information across scheduling platforms, inconsistently update changes to events across multiple platforms, and face integration issues while scheduling collaborative events and/or allocating work hours for focus time in such a technological landscape. Unlike conventional systems, the event synchronization system solves the problem of coordinating collaborative events and/or personal focus time allocations across different platforms and in accordance with varying user and organizational preferences, priorities, and goals. By utilizing a multimodal object synchronization model to generate proposed calendar entries based on various considerations, for example, the event synchronization system accurately and efficiently coordinates requested collaborative events and/or focus time allocations while requiring minimal user interactions compared to conventional systems.

Moreover, the event synchronization system improves computational efficiency over existing systems. For instance, unlike some existing systems that require actors to add the same calendar entry and process modifications to the corresponding entry on each calendaring platform (or third-party application), the event synchronization system can modify various events in a single calendaring platform (or third-party application) agnostic space and push the modifications to each calendaring platform. Thus, the event synchronization system does not spend computing resources redundantly processing the same information on different calendar platforms. In some cases, the event synchronization system can save computational resources by accounting for user-specific schedules and preferences across a variety of digital calendaring platforms.

Furthermore, the event synchronization system solves technological problems that specifically arose due to the technological environment in which digital calendaring platforms operate. Indeed, as discussed above, due to the nature of calendars syncing with one another over networks (e.g., the internet) and the advent of calendaring agents (both human and electronic) that have the ability to update calendar events simultaneously, there arose a technological problem of keeping electronic calendars free from event conflicts within a technological area where there is no single source of truth. Due to these technological problems, a calendar associated with a user account could easily become cluttered with overlapping events, with no specific technological solution for resolving the conflicts. While some platforms have developed hardline rules to avoid conflicts, these rules often only result in a constant change loop where one or more actors constantly change events based on one or more sets of defined rules or priority hierarches. The event synchronization system solves this problem by providing a process by which collaborative events and target allocations for other types of work activities (e.g., focus time) are intelligently scheduled in accordance with user preferences and existing schedules, thus solving the problems created specifically within the digital calendaring platforms.

In addition to the foregoing, in certain embodiments, the event synchronization system provides increased efficiency while maintaining data security by accessing private information across multiple user-specific calendars without disclosing or otherwise providing unauthorized access to unauthorized event participants. Also, the event synchronization system can significantly decrease the number of user interactions required to coordinate and confirm a collaborative event with multiple participants by processing the extracted information to generated proposed calendar entries according to one or more embodiments. These and other advantages of the one or more embodiments disclosed herein are further discussed in the paragraphs that follow and illustrated in the corresponding figures.

### Automated Scheduling of Collaborative Events

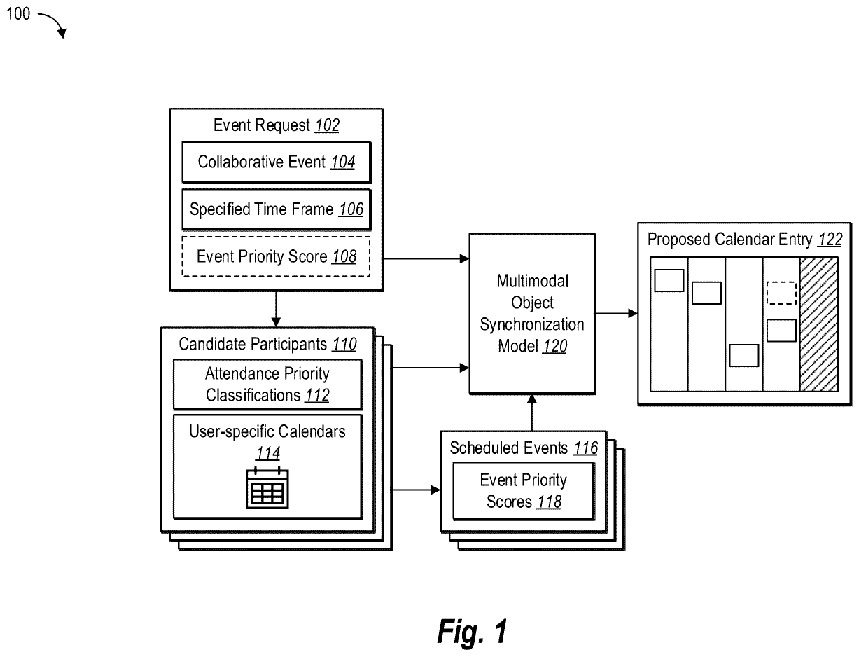

As mentioned above, the event synchronization system can intelligently organize collaborative events across multiple users and respective user-specific calendars based on a variety of considerations. To illustrate, FIG. 1 shows an example overview of an event synchronization system 100 generating a proposed calendar entry 122 for a requested collaborative event 104 in accordance with one or more embodiments.

As shown in FIG. 1, the event synchronization system 100 receives an event request 102 to schedule the collaborative event 104. A “collaborative event,” for example, includes or refers to an event or meeting including a plurality of participants or attendees, such as but not limited to remote or in-persons meetings, such as videoconferences, teleconferences, or a meeting or event held at a specified location. As also shown, the event request 102 includes a request to schedule the collaborative event 104 within a specified time frame 106, such as a particular period of time from receipt of the event request 102 or a specified range of dates and/or hours (e.g., during a specified week or other period).

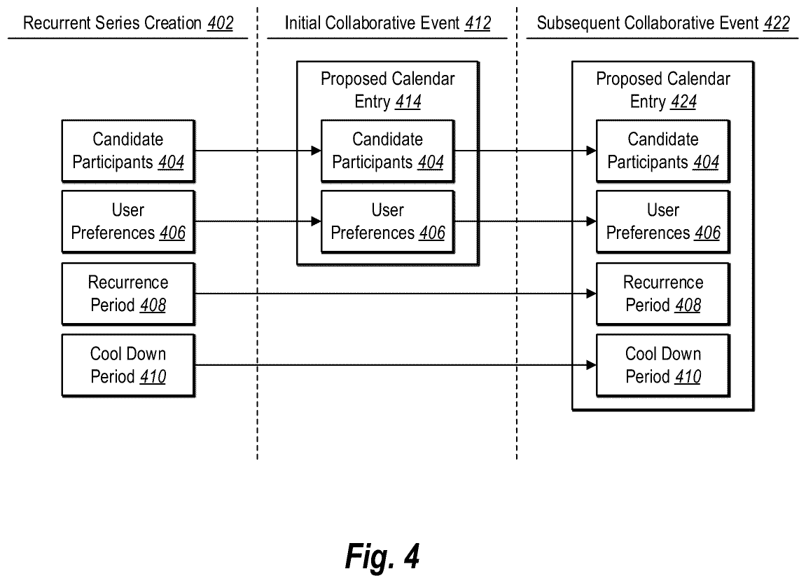

In some implementations, for example, the event synchronization system 100 receives the event request 102 from a client device associated with a user account of the event synchronization system 100. Alternatively, in some implementations, the event synchronization system 100 generates or otherwise identifies the event request 102 to responsively schedule the collaborative event 104. In some cases, for example, the event synchronization system 100 generates the event request 102 in response to scheduling or completion of an event within a recurrent series of events (e.g., as described in further detail below in relation to FIG. 4). In another example, the event synchronization system 100 provides an option at a conclusion of an event (e.g., a remote conference hosted by the event synchronization system 100 or a system associated with the event synchronization system 100) to one or more event participants, such as an event organizer, to schedule a subsequent collaborative event within a specified period of time.

As also shown in FIG. 1, the event synchronization system 100 receives (or otherwise identifies) multiple candidate participants 110 for the requested collaborative event 104. In some embodiments, for example, the event request 102 includes a list of the candidate participants 110 for the collaborative event 104. In one or more embodiments, the event synchronization system 100 determines or suggests the candidate participants 110 for the collaborative event 104 (e.g., based on event attributes, related prior or scheduled events, and/or historical data associated with similar events).

As illustrated in FIG. 1, the event synchronization system 100 determines, receives, or otherwise identifies corresponding attendance priority classifications 112 for the candidate participants 110. An “attendance priority classification,” for example, includes or refers to an indicated level of importance or relative priority for a respective candidate participant's attendance in a particular collaborative event. In some embodiments, for example, the attendance priority classifications 112 for the candidate participants 110 respectively indicate whether each candidate participant's attendance is “required” or “optional” for the collaborative event 104. Additionally or alternatively, in some embodiments, the attendance priority classifications 112 include a relative priority ranking of the candidate participants 110 and/or a priority score indicating the relative ranking or importance of each of the candidate participants 110.

As shown in FIG. 1, the event synchronization system 100 identifies scheduled events 116 from user-specific calendars 114 respectively associated with the candidate participants 110. In some embodiments, for example, the event synchronization system 100 identifies the scheduled events 116 within the specified time frame 106 on each of the user-specific calendars 114 as potential conflicts for the collaborative event 104. Also, the event synchronization system 100 identifies, receives, or otherwise determines corresponding event priority scores 118 for the scheduled events 116 identified on the user-specific calendars. Further, the event request 102 also includes an event priority score 108 for the collaborative event 104. An “event priority score,” for example, indicates a relative importance of an event in relation to other scheduled or proposed events on a particular user-, team-, or organization-specific calendar.

In some embodiments, for example, the event priority score 108 is set by a user (e.g., an event coordinator who requested the collaborative event 104). Accordingly, in some embodiments, the event priority scores 118 for the scheduled events 116 are also set by respective users upon scheduling, proposing, or requesting each event. Alternatively, in some embodiments, the event priority score 108 for the requested collaborative event 104 and/or the event priority scores 118 for the scheduled events 116 are determined by the event synchronization system 100 based on respective event attributes (e.g., event title, subject, participants, historical data, and/or metadata). Moreover, in some embodiments, the event synchronization system 100 requests or otherwise enables user selection of an event priority score for a given requested or scheduled event but optionally determines, in absence of a user selection, the event priority score for the given event, such that event priority scores are made available for consideration in coordinating events according to one or more embodiments.

As further illustrated in FIG. 1, the event synchronization system 100 utilizes a multimodal object synchronization model 120 to process the various inputs provided by the event synchronization system 100 for generating the proposed calendar entry 122 for the requested collaborative event 104. A “multimodal object synchronization model,” for example, includes or refers to a model configured to process multiple categories of input objects to generate an output (e.g., a proposed calendar entry or other outputs discussed herein) which optimizes the synchronicity between the input objects. In other words, a multimodal object synchronization model, according to one or more embodiments, generates an optimal solution based on various inputs. A multimodal object synchronization model can include but is not limited to an algorithmic model, a probabilistic model, a machine learning-based model (e.g., a random forest), or a neural network.

Accordingly, as shown in FIG. 1, the event synchronization system 100 utilizes the multimodal object synchronization model 120 to generate the proposed calendar entry 122 based at least on the event priority score 108 set or determined for the collaborative event 104, the scheduled events 116 and their corresponding event priority scores 118, and the attendance priority classifications 112 for the candidate participants 110. A “proposed calendar entry,” for example, includes or refers to a proposal for a scheduled event to be entered onto the calendars of candidate participants of the proposed event. In some embodiments, for example, a proposed calendar entry comprises a calendar invitation which is distributed by the event synchronization system 100 to candidate participants for respective acceptance or rejection (or tentative acceptance) of the calendar invitation. In some implementations, the proposed calendar entry 122 includes multiple proposed dates/times for the collaborative event 104, such that the candidate participants may select one or more preferred dates/times and/or rank the proposed dates/times by preference.

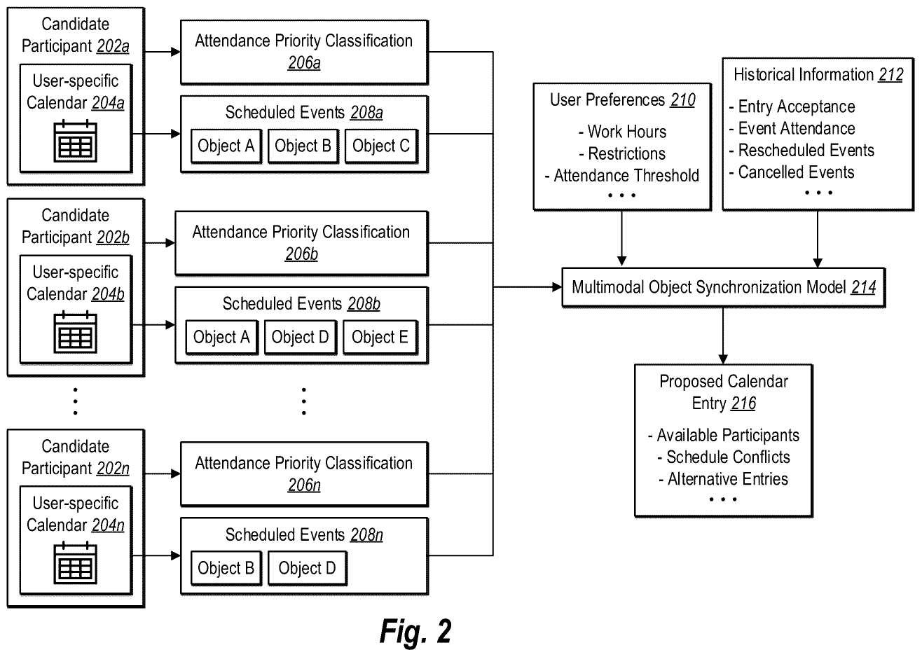

As indicated above, in some embodiments, the event synchronization system 100 extracts and processes information from various sources across multiple user accounts to generate a proposed calendar entry using a multimodal object synchronization model. For example, FIG. 2 illustrates the event synchronization system 100 utilizing a multimodal object synchronization model 214 to generate a proposed calendar entry 216 in accordance with one or more embodiments.

As shown in FIG. 2, the event synchronization system 100 determines, identifies, or otherwise receives candidate participants 202a, 202b, through 202n for a requested collaborative event. In some embodiments, for example, the event synchronization system 100 receives a list of the candidate participants 202a-202n within a request to schedule a collaborative event. Alternatively, in some embodiments, the event synchronization system 100 determines or identifies the candidate participants 202a-202n based on prior events or user preferences and/or presents potential candidate participants to a user for acceptance/selection of the candidate participants 202a-202n therefrom.

As also shown in FIG. 2, the event synchronization system 100 determines, identifies, or otherwise receives respective attendance priority classifications 206a, 206b, through 206n for the candidate participants 202a-202n. As mentioned above, for example, the event synchronization system 100 receives a request to schedule a collaborative event which includes the respective attendance priority classifications 206a-206n for the candidate participants 202a-202n. Alternatively, in some embodiments, the event synchronization system 100 determines the respective attendance priority classifications 206a-206n for the candidate participants 202a-202n based on event attributes or historical data and/or presents suggested attendance priority classifications to a user for acceptance or modification thereof.

As further illustrated in FIG. 2, the event synchronization system 100 accesses user-specific calendars 204a, 204b, through 204n associated with the candidate participants 202a-202n to identify scheduled events 208a, 208b, through 208n (e.g., within a specified time frame for scheduling a requested collaborative event). As mentioned previously, in one or more embodiments, the event synchronization system 100 accesses private information across multiple user-specific calendars, such as the scheduled events 208a-208n and corresponding event attributes and metadata, without disclosing or otherwise providing unauthorized access to unauthorized event participants.

As illustrated, in some implementations, the event synchronization system 100 identifies scheduled events on a first user-specific calendar associated with a first candidate participant (e.g., the scheduled events 208a from the user-specific calendar 204a associated with the candidate participant 202a) that differ from scheduled events on a second user-specific calendar associated with a second candidate participant (e.g., the scheduled events 208b from the user-specific calendar 204b associated with the candidate participant 202b). Accordingly, in one or more embodiments, the event synchronization system 100 also identifies duplicate scheduled events within the extracted scheduled events 206a-206n and withdraws the duplicate scheduled events from consideration when generating the proposed calendar entry 216. In some embodiments, the event synchronization system 100 identifies duplicate calendar events across different calendaring platforms (e.g., user-specific calendars hosted by different third-party calendar applications) by comparing event attributes and/or metadata of respective scheduled events identified on the user-specific calendars hosted by the different calendaring platforms.

As also shown in FIG. 2, the event synchronization system 100 utilizes the multimodal object synchronization model 214 to generate the proposed calendar entry 216 based on various inputs including one or more of: (i) the attendance priority classifications 206a-206n for the candidate participants 202a-202n, (ii) the scheduled events 208a-208n from the user-specific calendars 204a-204n associated with the candidate participants 202a-202n, (iii) event priority scores for the scheduled events 208a-208n and the requested collaborative event (e.g., as described above in relation to FIG. 1), (iv) user preferences 210, and/or (v) historical information 212.

As illustrated, the user preferences 210 can include (but are not limited to) work hours (e.g., 9:00 a to 5:00 p), scheduling restrictions (e.g., no collaborative meetings before 9:00 a), or an attendance threshold (e.g., a minimum number of attendees required to hold the event). In various implementations, for example, the user preferences are selected by a user requesting the collaborative event, selected by the candidate participants 202a-202n, and/or determined by an account administrator for an organization, group, or team associated with the collaborative event. As also illustrated, the historical information 212 can include (but is not limited to) historical data/records associated with prior calendar entries and/or prior scheduled event, such as acceptance/rejection of proposed calendar entries, collaborative event attendance, and rescheduled or canceled events with, in some cases, corresponding justifications therefor.

As further shown in FIG. 2, the event synchronization system 100 utilizes the multimodal object synchronization model 214 to process these various inputs to generate the proposed calendar entry 216. As illustrated, in some embodiments, the event synchronization system 100 provides contextual information with the proposed calendar entry 216 (e.g., when sending the proposed calendar entry 216 to the candidate participants 202a-202n), such as but not limited to: a listing of available participants (e.g., candidate participants with no conflicting scheduled events), an indication of schedule conflicts on one or more of the user-specific calendars 204a-204c, and/or one or more alternative proposed calendar entries for the collaborative event.

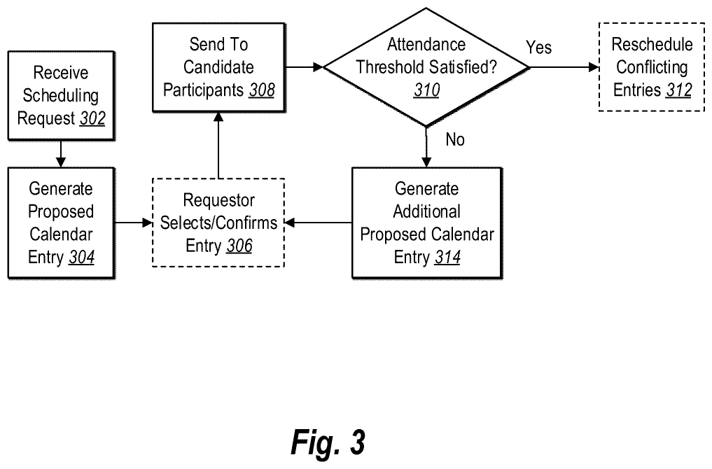

As indicated above, in some embodiments, the event synchronization system 100 coordinates requested events across multiple user-specific calendars in an automated manner by generating proposed calendar entries for requested events based on a variety of factors. For example, FIG. 3 illustrates the event synchronization system 100 proposing and implementing calendar entries in accordance with one or more embodiments.

As shown in FIG. 3, the event synchronization system 100 receives, at 302, a request to schedule a collaborative event. In some embodiments, for example, the event synchronization system 100 receives the scheduling request from a user account. Alternatively, in some embodiments, the event synchronization system 100 generates the request for, or otherwise initiates a process for, scheduling a collaborative event for a recurrent series of collaborative events. In response, as shown in FIG. 3, the event synchronization system 100 generates, at 304, a proposed calendar entry for the requested event (e.g., as described above in relation to FIGS. 1-2).

In some embodiments, the event synchronization system 100 receives, at 306, a confirmation of the proposed calendar entry, generated at 304, prior to sending, at 308, the proposed calendar entry to candidate participants. In one or more embodiments, the event synchronization system 100, at 304, generates a proposed calendar entry comprising multiple options for user selection and presents the multiple options to the requesting user or administrator, upon which the event synchronization system 100 receives a user selection of an individual calendar entry at 306. In some embodiments, the event synchronization system 100 sends the proposed calendar entry with multiple selectable options to the candidate participants to poll the candidate participants and select the proposed calendar entry accordingly. Alternatively, in one or more embodiments, the event synchronization system 100 sends an individual proposed calendar entry to the candidate participants without requiring confirmation from a user account associated with the scheduling request.

As also shown in FIG. 3, the event synchronization system 100 determines, at 310, whether an attendance threshold is satisfied for the proposed calendar entry. In some embodiments, for example, the event synchronization system 100 receives responses from the candidate participants in which each candidate participant either accepts, rejects, or tentatively accepts the proposed calendar entry. In some embodiments, for example, the event synchronization system 100 receives or identifies an attendance threshold for the requested collaborative event, the attendance threshold comprising one or more of: a minimum number of acceptances of the proposed collaborative event from the candidate participants, a minimum number of acceptances from candidate participants having an attendance priority classification above a predetermined level, or a minimum aggregate priority score of candidate participants for which acceptances are received (e.g., based on the attendance priority classifications of the candidate participants for which acceptances are received).

As further shown in FIG. 3, in some cases, the event synchronization system 100 reschedules, at 312, one or more calendar entries (e.g., scheduled events) which conflict with the proposed calendar entry to allow for scheduling of the requested collaborative event according to the proposed calendar entry. In some embodiments, upon proposing and/or scheduling a conflicting event, the event synchronization system 100 generates a proposed calendar entry for the previously scheduled event (e.g., as described above in relation to FIGS. 1-2). In cases wherein, at 310, the event synchronization system 100 determines that the proposed calendar entry (sent to the candidate participants at 308) fails to satisfy an attendance threshold and, in response, generates, an additional proposed calendar entry at 314, repeating the foregoing acts 306-310 until a proposed calendar entry satisfies the attendance threshold or until the request is withdrawn.

As indicated above, in some embodiments, the event synchronization system 100 coordinates calendar entries across user-specific calendars for recurring collaborative events. For example, FIG. 4 illustrates the event synchronization system 100 generating proposed calendar entries for a recurrent series of collaborative events in accordance with one or more embodiments.

As shown in FIG. 4, the event synchronization system 100, at a recurrent series creation 402, identifies, receives, or otherwise determines a set of candidate participants 404, one or more user preferences 406 (e.g., as described above in relation to FIG. 2), a recurrence period 408, and a cool down period 410 for a recurrent series of collaborative events. A “recurrence period,” for example, includes or refers to an interval at which a recurring event repeats (e.g., weekly, monthly, or any specified period). Moreover, a “cool down period,” for example, includes or refers to a requisite amount of time between events of a recurrent series as specified by a user, organization, or global setting of the event synchronization system 100. To illustrate, given a recurrence period of monthly and a cool down period of 10 business days for a given recurrent series of events, in some embodiments, the event synchronization system 100 automatedly generates proposed calendar entries for subsequent events of the given recurrent series during each month without proposing/scheduling subsequent events with less than 10 business days therebetween.

As further illustrated in FIG. 4, the event synchronization system 100 generates a proposed calendar entry 414 for an initial collaborative event 412 based at least in part on the candidate participants 404 (e.g., the respective availability and attendance priority classifications of the candidate participants 404) and the user preferences 406. In some embodiments, for example, the event synchronization system 100 generates the proposed calendar entry utilizing a multimodal object synchronization model as described above (e.g., in relation to FIGS. 1-3).

As also shown in FIG. 4, the event synchronization system 100 generates a proposed calendar entry 424 for a subsequent collaborative event 422 (e.g., after the initial collaborative event 412 has been scheduled and/or carried out). As shown, the event synchronization system 100 includes the candidate participants 404 in the proposed calendar entry 424, both (i) for generating the proposed calendar entry 424 in consideration of scheduled events on user-specific calendars of the candidate participants 404 and (ii) as an invitee list for the proposed calendar entry 424. Accordingly, in some implementations, unlike conventional digital scheduling platforms, the event synchronization system 100 includes invitees on the proposed calendar entry 424 for the subsequent collaborative event 422 that rejected the proposed calendar entry 414 for the initial collaborative event 412 (or any prior event in the recurrent series). Furthermore, the event synchronization system 100 also maintains the user preferences 406 when generating and/or scheduling the proposed calendar entry 424 for the subsequent collaborative event 422 (while allowing for user implemented changes thereto).

As mentioned, in some embodiments, the event synchronization system 100 implements recurrent events with a flexible recurrence period, thus enabling the event synchronization system 100 to coordinate events within a given recurrent series across multiple calendars with flexible event dates/times. As illustrated in FIG. 4, for instance, the event synchronization system 100 generates the proposed calendar entry 424 for holding the subsequent collaborative event 422 within the recurrence period 408, rather than merely scheduling events of the recurrent series at an exact interval (e.g., at the same date/time of each month in a monthly recurring series). As also shown, the event synchronization system 100 utilizes the cool down period 410 to ensure that the subsequent collaborative event 422 is not proposed/scheduled with insufficient time between the initial collaborative event 412 and the subsequent collaborative event 422.

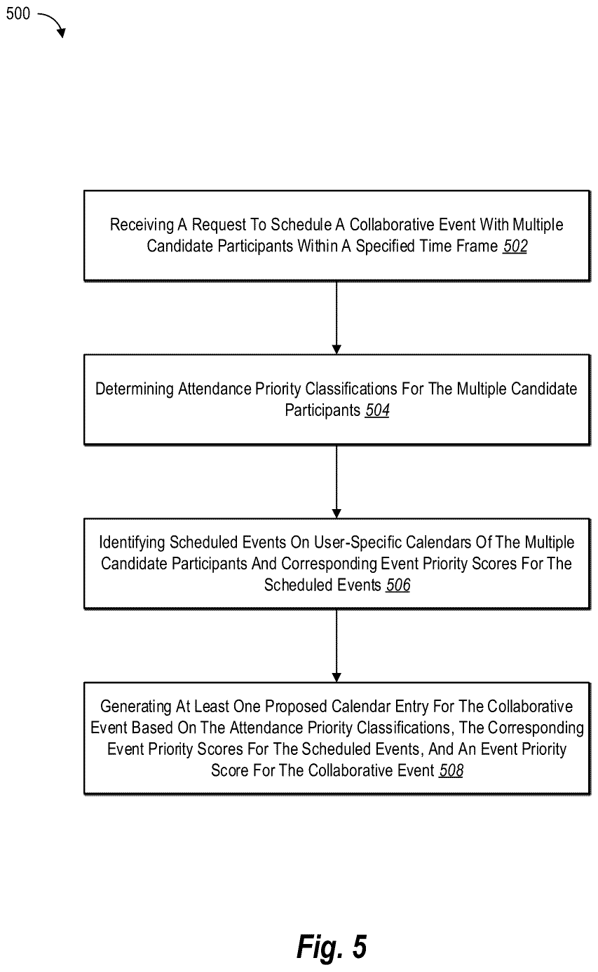

FIGS. 1-4, the corresponding text and the examples provide a number of different systems and methods for organizing collaborative events across multiple user-specific calendars utilizing a multimodal object synchronization model, as well as various related features of embodiments of the event synchronization system 100. In addition to the foregoing, implementations can also be described in terms of flowcharts comprising acts/steps in a method for accomplishing a particular result. For example, FIG. 5 illustrates an example flowchart of a series of acts for generating a proposed calendar entry for a requested collaborative event in accordance with one or more embodiments.

While FIG. 5 illustrates acts according to one embodiment, alternative embodiments may omit, add to, reorder, and/or modify any of the acts shown in FIG. 5. The acts of FIG. 5 can be performed as part of a method. Alternatively, a non-transitory computer-readable medium can comprise instructions that, when executed by one or more processors, cause a computing device to perform the acts of FIG. 5. In some embodiments, a system can perform the acts of FIG. 5.

As shown in FIG. 5, the series of acts 500 may include an act 502 of receiving a request to schedule a collaborative event with multiple candidate participants within a specified time frame, an act 504 of determining attendance priority classifications for the multiple candidate participants, and act 506 of identifying scheduled events on user-specific calendars of the multiple candidate participants and corresponding event priority scores for the scheduled events, and an act 508 of generating at least one proposed calendar entry for the collaborative event based on the attendance priority classifications, the corresponding event priority scores for the scheduled events, and an event priority score for the collaborative event.

In one or more embodiments, for example, the series of acts 500 includes receiving a request to schedule a collaborative event with multiple candidate participants within a specified time frame, determining attendance priority classifications for the multiple candidate participants, identifying scheduled events on user-specific calendars of the multiple candidate participants, determining corresponding event priority scores for the scheduled events on the user-specific calendars of the multiple candidate participants, and generating at least one proposed calendar entry for the collaborative event based on the attendance priority classifications, the corresponding event priority scores for the scheduled events, and an event priority score for the collaborative event.

Moreover, in some embodiments, determining the attendance priority classifications for the multiple candidate participants comprises identifying a priority ranking of the multiple candidate participants for the collaborative event. In one or more embodiments, generating the at least one proposed calendar entry for the collaborative event is further based on a selected threshold number of required participants for the collaborative event. In some embodiments, determining the corresponding event priority scores for the scheduled events on the user-specific calendars of the multiple candidate participants comprises extracting and comparing event attributes across the scheduled events and to determine the corresponding event priority scores relative to the collaborative event.

Further, in one or more embodiments, generating the at least one proposed calendar entry for the collaborative event is further based on selected preferences comprising one or more of organization-specific work hours, attendee-specific work hours, schedule restrictions, or time-zone related adjustments. In some embodiments, generating the at least one proposed calendar entry for the collaborative event is further based on historical information comprising one or more of prior acceptances of proposed calendar entries, prior participant attendance of scheduled events, occurrences of event rescheduling, or occurrences of canceled events.

Also, in some embodiments, generating the at least one proposed calendar entry for the collaborative event comprises generating multiple alternative proposed calendar entries based on the attendance priority classifications, the corresponding event priority scores for the scheduled events, and an event priority score for the collaborative event and providing, for display on a client device associated with the request to schedule the collaborative event, the multiple alternative proposed calendar entries. Additionally, in one or more embodiments, the series of acts 500 further includes receiving, via the client device associated with the request to schedule the collaborative event, a user selection of a selected calendar entry from the multiple alternative proposed calendar entries and, in response to receiving the user selection, proposing the selected calendar entry on each of the user-specific calendars of the multiple candidate participants.

In some embodiments, the series of acts 500 further includes identifying the scheduled events on the user-specific calendars of the multiple candidate participants across a plurality of different calendaring platforms. Also, in one or more embodiments, identifying the corresponding event priority scores includes comparing respective event attributes extracted from the user-specific calendars across the plurality of different calendaring platforms. Further, in one or more embodiments, the series of acts 500 further includes generating the at least one proposed calendar entry further based on selected preferences and historical data associated with prior collaborative events.

Moreover, in some embodiments, generating the at least one proposed calendar entry includes utilizing a multimodal object synchronization model to analyze the attendance priority classifications, the corresponding event priority scores for the scheduled events, and an event priority score for the collaborative event. Also, in one or more embodiments, utilizing the multimodal object synchronization model to generate the at least one proposed calendar entry further includes generating a plurality of candidate calendar entries based on the attendance priority classifications, the corresponding event priority scores for the scheduled events, and an event priority score for the collaborative event and comparing the plurality of candidate calendar entries to generate the at least one proposed calendar entry.

To further illustrate, in one or more embodiments, the series of acts 500 includes receiving a request to schedule a collaborative event with multiple candidate participants within a specified time frame, determining attendance priority classifications for the multiple candidate participants, identifying scheduled events on user-specific calendars of the multiple candidate participants and corresponding event priority scores for the scheduled events, and generating at least one proposed calendar entry for the collaborative event based on the attendance priority classifications, the corresponding event priority scores for the scheduled events, and an event priority score for the collaborative event.

Furthermore, in some embodiments, the series of acts 500 further includes receiving the request to schedule the collaborative event for a series of recurrent collaborative events and/or determining the specified time frame for scheduling the collaborative event based on a selected period of recurrence and a threshold minimum time between recurrent events. Also, in one or more embodiments, the series of acts 500 further includes identifying the multiple candidate participants for the collaborative event based on a listing of candidate participants from a prior event of the series of recurrent collaborative events, the listing of candidate participants including attendees and non-attendees of the prior event.

In one or more embodiments, determining the attendance priority classifications for the multiple candidate participants includes identifying required participants and a threshold minimum number of participants for the collaborative event. In some embodiments, the series of acts 500 further includes generating an additional proposed calendar entry in response to receiving one or more rejections of the at least one proposed calendar entry.

### Automated Focus Time Allocations

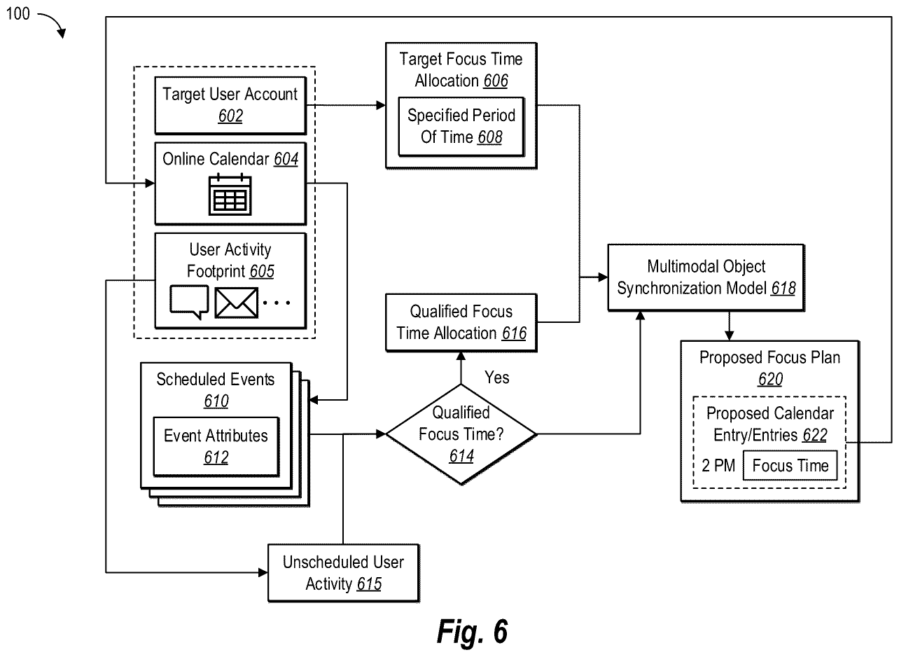

As mentioned above, in some embodiments, the event synchronization system 100 can intelligently allocate a target amount of focus time for a target user account utilizing a multimodal object synchronization model to manage calendar entries of an online calendar associated with the target user. To illustrate, FIG. 6 shows an example overview of the event synchronization system 100 generating a proposed focus plan 620 for a target focus time allocation 606 in accordance with one or more embodiments.

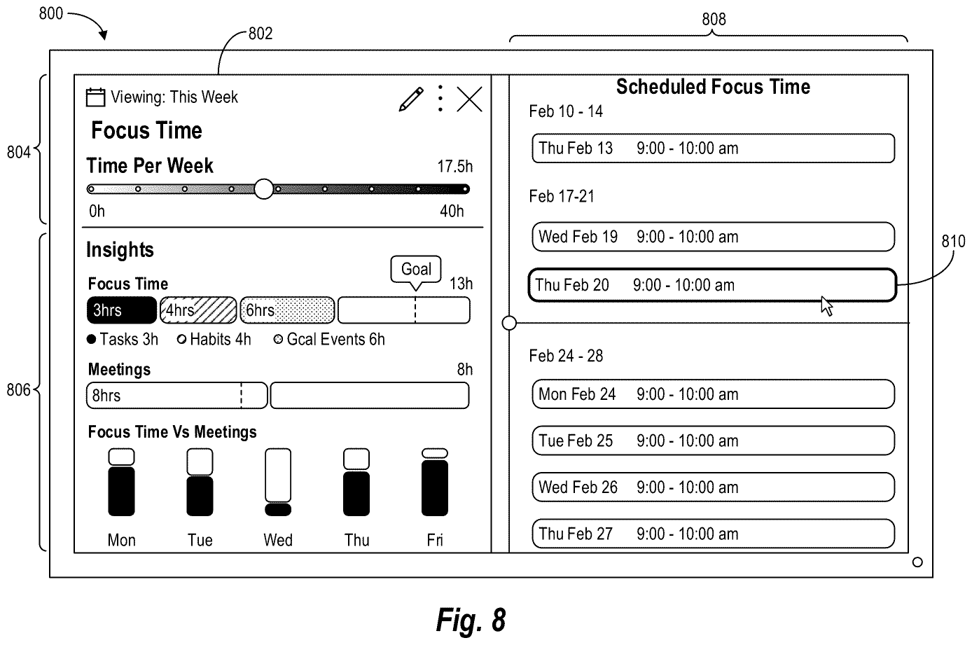

As shown in FIG. 6, the event synchronization system 100 determines, receives, or otherwise identifies, for a target user account 602, the target focus time allocation 606 over a specified period of time 608. A “target focus time allocation,” for example, includes or refers to a measure of time allocated within a given period for focused productivity, as opposed to collaborative events and other events or tasks determined to be unqualified as “focus time” (e.g., as specified by an individual or organization). In some embodiments, for example, the event synchronization system 100 receives the target focus time allocation 606 and/or the specified period of time via user interactions with a client device associated with the target user account 602 (e.g., as further described below in relation to FIG. 8) or per a predetermined setting established by an administrator account (e.g., for an organization associated with the target user account 602). Moreover, in some embodiments, the event synchronization system 100 identifies or determines adjustments to the target focus time allocation 606 for the specified period of time 608 based on information from a prior period of time (e.g., based on actual focus time allocations from previously completed periods).

As also shown in FIG. 6, the event synchronization system 100 accesses an online calendar 604 associated with the target user account 602 (e.g., a user-specific calendar associated with the target user account 602). In some embodiments, the online calendar 604 is directly integrated or hosted by the event synchronization system 100. Alternatively, in some embodiments, the online calendar 604 comprises a user-specific calendar hosted by a third-party application.

As illustrated, the event synchronization system 100 identifies one or more scheduled events 610 on the online calendar 604 associated with the target user account 602 and extracts or otherwise identifies corresponding event attributes 612 for the one or more scheduled events 610, such as but not limited to titles, descriptions, candidate participants, or metadata associated with the scheduled events 610. Based on the corresponding event attributes 612, the event synchronization system 100 makes a determination 614 of whether each event of the scheduled events 610 constitutes a qualified focus time event. A “qualified focus time event,” for example, includes or refers to an event or calendar entry which qualifies, in whole or in part, as focus time according to one or more specified qualifications (e.g., as specified by an individual or organization). As mentioned, the event synchronization system 100 identifies a given scheduled event (e.g., of the scheduled events 610 on the online calendar 604) as a qualified focus time event by analyzing the event attributes (e.g., of the event attributes 612) for the given scheduled event.

Furthermore, in one or more embodiments, the event synchronization system 100 determines a user activity footprint 605 associated with the target user account 602 to identify instances of unscheduled user activity 615. A “user activity footprint,” for example, includes or refers to a record of user interactions with digital systems associated and/or integrated with a user account, including but not limited to application usage, communication activity, document editing, media consumption, and system presence indicators. Relatedly, “unscheduled user activity,” includes or refers to user interactions or behaviors (e.g., derived from a user activity footprint) that occur outside of scheduled calendar events and occupy identifieable time intervals.

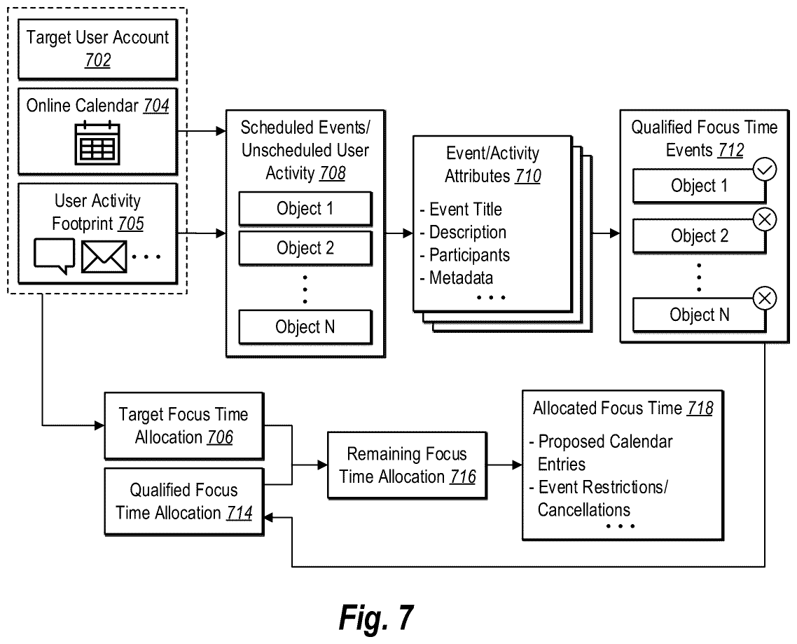

As shown in FIG. 6, the event synchronization system 100 determines, from the user activity footprint 605, the unscheduled user activity 615—such as but not limited to document editing, instant messaging, media consumption, or ad-hoc collaborative meetings—and makes the determination 614 of whether the unscheduled user activity 615 (or discrete intervals thereof) constitutes a qualified focus time event (e.g., as further described below in relation to FIG. 7).

For each of the scheduled events 610 and/or intervals of the unscheduled user activity 615 identified as qualified focus time events, the event synchronization system 100 determines a qualified focus time allocation 616. A “qualified focus time allocation,” for example, includes or refers to a measure of time determined to constitute focus time according to one or more qualifications (e.g., as specified by an individual or organization). Accordingly, for each qualified focus time event of the scheduled events 610 and/or the unscheduled user activity 615, the event synchronization system 100 determines a measure of time to include within the qualified focus time allocation 616. In some cases, for instance, the event synchronization system 100 determines the entire measure of time of a scheduled event or interval of unscheduled activity to count towards the qualified focus time allocation 616. In other cases, the event synchronization system may determine that only a portion of the time of the scheduled event or interval of unscheduled activity counts towards the qualified focus time allocation 616.

As also shown in FIG. 6, the event synchronization system 100 utilizes a multimodal object synchronization model 618 (e.g., such as described above in relation to FIGS. 1-2) to generate the proposed calendar entry 620 based on the qualified focus time allocation 616 and the target focus time allocation 606. In some embodiments, for example, the event synchronization system 100 subtracts the qualified focus time allocation 616 from the target focus time allocation 606 to determine a remaining focus time allocation and, in response, generates the proposed focus plan 620. In some implementations, for example, the event synchronization system 100 generates one or more proposed calendar entries 622 to schedule additional focus time towards the remaining focus time allocation. Additionally or alternatively, in some implementations, the event synchronization system 100 generates one or more proposed goals for periodic focus time, such as but not limited to a daily or weekly target without providing specifically scheduled time intervals for the user to engage in the proposed focus time.

As indicated above, in some embodiments, the event synchronization system 100 identifies one or more scheduled events as qualified focus time events and, in response, coordinates additional scheduled focus time towards a target focus time allocation for a target user account. For example, FIG. 7 illustrates the event synchronization system 100 identifying qualified focus time events 712 and determining allocated focus time 718 for a target user account 702 in accordance with one or more embodiments.

As shown in FIG. 7, the event synchronization system 100 determines, for the target user account 702, a target focus time allocation 706 over a specified period of time. Further, the event synchronization system 100 identifies multiple scheduled events and/or unscheduled user activity 708 on an online calendar 704 and/or a user activity footprint 705 respectivley associated with the target user account 702 (e.g., Object 1 through Object N). In some embodiments, for example, the event synchronization system 100 determines or otherwise receives the user activity footprint 605 from one or more applications associated with the target user account 702, such as but not limited to messaging applications, email applications, collaborative activity feeds, or other applications associated with and/or integrated with the target user account 602.

As further illustrated, the event synchronization system 100 extracts, determines, or otherwise identifies event and/or activity attributes 710 corresponding to the scheduled events and/or unscheduled user activity 708. As shown, for example, the event/activity attributes 710 for each of the scheduled events/unscheduled user activity 708 include (but are not limited to) one or more of: an event title, an event description, a list of event participants (or invitees), or associated metadata (e.g., event category/type indicators available on some third-party calendaring platforms).

As also shown in FIG. 7, the event synchronization system 100 identifies one or more of the scheduled events/unscheduled user activity 708 as qualified focus time events 712. In the illustrated example, for instance, the event synchronization system 100 identifies at least a first calendar entry or interval of unscheduled user activity (Object 1) of the scheduled events 708 as a qualified focus time event while determining that at least a second calendar entry or interval of unscheduled user activity (Object 2) does not constitute a qualified focus time event. As also shown in the illustrated embodiment, the event synchronization system 100 identifies the qualified focus time events 712 from the scheduled events/unscheduled user activity 708 based on the event attributes 710 corresponding to the scheduled events/unscheduled user activity 708. Alternatively, in some embodiments, the event synchronization system 100 identifies one or more events and/or intervals of the scheduled events/unscheduled user activity 708 as qualified focus time events 712 based on user interactions. In other words, in some embodiments, the event synchronization system 100 receives an indication (e.g., via a user interaction with a client device associated with the target user account 702) that one or more events and/or intervals of the scheduled events/unscheduled user activity 708 constitutes qualified focus time.

Based on the qualified focus time events 712 identified from the scheduled events/unscheduled user activity 708, the event synchronization system 100 determines a qualified focus time allocation 714 (e.g., as described above in relation to FIG. 6) and deducts the qualified focus time allocation 714 from the target focus time allocation 706 to determine a remaining focus time allocation 716 for the specified period of time. In response, the event synchronization system 100 generates and/or schedules the allocated focus time 718. In some embodiments, for instance, the event synchronization system 100 generates one or more proposed calendar entries to completely or partially cover the remaining focus time allocation 716. In one or more embodiments, the event synchronization system utilizes a multimodal object synchronization model to automate generation of the proposed calendar entries for scheduled focus time on the online calendar 704 (e.g., as described above in relation to FIGS. 1-2).

Alternatively or additionally, in one or more embodiments, the event synchronization system 100 implements one or more event restrictions and/or cancellations to ensure that the online calendar 704 associated with the target user account 702 includes availability for sufficient focus time to completely or partially cover the remaining focus time allocation 716. In some embodiments, for example, the event synchronization system 100 restricts new calendar entries during the specified period of time for the target focus time allocation 706 and/or notifies the target user account 702 when scheduled events not identified as qualified focus time events are preventing implementation of the target focus time allocation 706 on the online calendar 704.

As indicated above, in some embodiments, the event synchronization system 100 provides a user interface on a client device for interacting with various elements of the event synchronization system 100, such as proposed calendar entries for collaborative, recurrent, or focus time events and information associated with target focus time allocations for a target user account. For example, FIG. 8 illustrates an exemplary user interface 802 for interacting with the event synchronization system 100 in accordance with one or more embodiments.

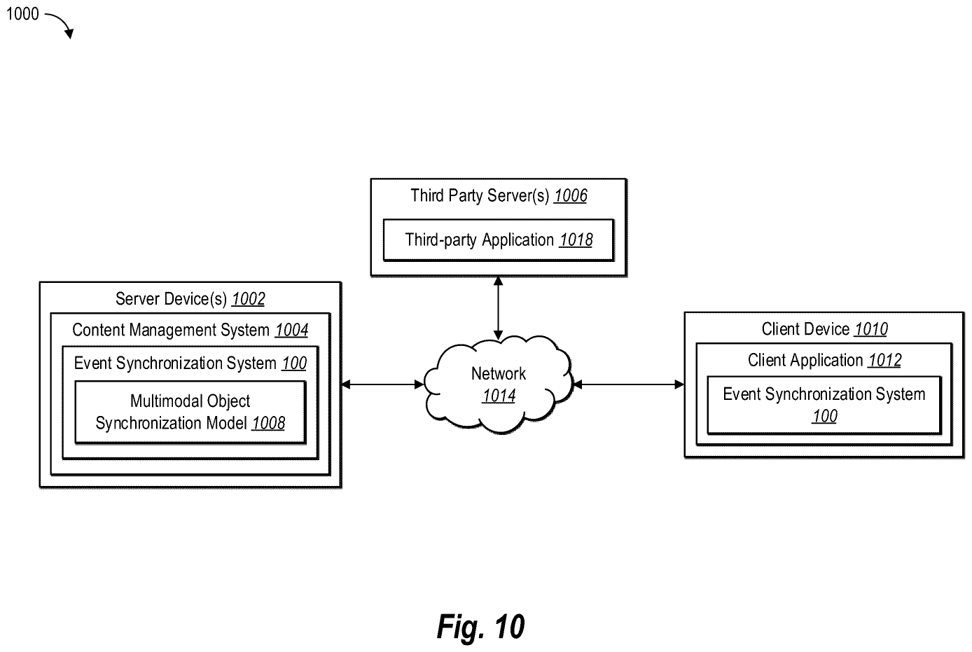

As shown in FIG. 8, the event synchronization system 100 provides the user interface 802 via a client device 800 associated with a target user account of the event synchronization system 100 (e.g., as described below in relation to FIGS. 10-12). In the illustrated example, the user interface 802 comprises various selectable options and informational graphics for initiating, adjusting, and/or managing focus time allocations within a target user account.

For instance, the user interface 802 includes a graphical representation 804 of a target focus time allocation during a weekly time period. As shown, the graphical representation 804 includes an actionable interface (e.g., a slider) for adjusting the target focus time allocation. Accordingly, in some implementations, the event synchronization system 100 receives the target focus time allocation based on user interactions with the client device 800.

Also, the user interface 802 includes a plurality of informational graphics 806 providing insights related to progress towards the target focus time allocation for the specified time period. As shown, the informational graphics 806 include a visual breakdown of scheduled focus time allocations and other scheduled events (e.g., meetings). Accordingly, the event synchronization system 100 provides, via the user interface 802 on the client device 800, a visual representation of information related to achieving the target focus time set by user interaction with the actionable interface within the graphical representation 804.

Further, the user interface 802 includes a graphical representation 808 of scheduled focus time events on a user-specific calendar (e.g., an online calendar) associated with the target user account. In some embodiments, for example, a user can interact with a scheduled focus time event 810 within the graphical representation 808 to reschedule, cancel, or otherwise adjust one or more attributes of the scheduled focus time event 810.

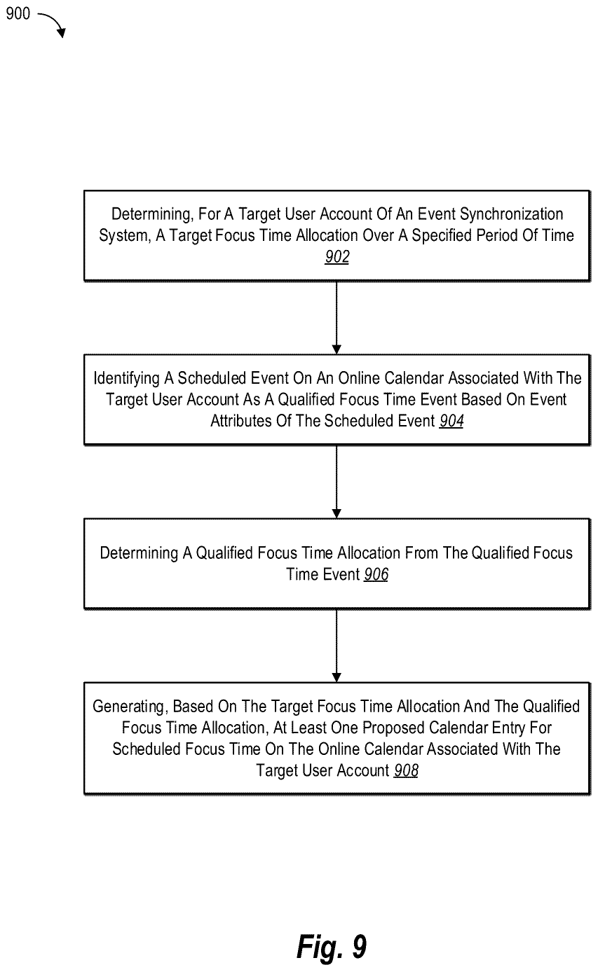

FIGS. 6-8, the corresponding text and the examples provide a number of different systems and methods for intelligently allocating focus time on a target user's schedule according to user preferences and in consideration of existing scheduled events for the target user. In addition to the foregoing, implementations can also be described in terms of flowcharts comprising acts/steps in a method for accomplishing a particular result. For example, FIG. 9 illustrates an example flowchart of a series of acts for generating a proposed calendar entry for a target focus time allocation in accordance with one or more embodiments.

While FIG. 9 illustrates acts according to one embodiment, alternative embodiments may omit, add to, reorder, and/or modify any of the acts shown in FIG. 9. The acts of FIG. 9 can be performed as part of a method. Alternatively, a non-transitory computer-readable medium can comprise instructions that, when executed by one or more processors, cause a computing device to perform the acts of FIG. 9. In some embodiments, a system can perform the acts of FIG. 9.

As shown in FIG. 9, the series of acts 900 may include an act 902 of determining, for a target user account of an event synchronization system, a target focus time allocation over a specified period of time, an act 904 of identifying a scheduled event on an online calendar associated with the target user account as a qualified focus time event based on event attributes of the scheduled event, an act 906 of determining a qualified focus time allocation from the qualified focus time event, and an act 908 of generating, based on the target focus time allocation and the qualified focus time allocation, at least one proposed calendar entry for scheduled focus time on the online calendar associated with the target user account.

For instance, in some embodiments, the series of acts 900 includes determining, for a target user account of an event synchronization system, a target focus time allocation over a specified period of time, extracting event attributes of a scheduled event on an online calendar associated with the target user account, identifying the scheduled event as a qualified focus time event based on the event attributes, determining a qualified focus time allocation from the qualified focus time event, and generating, based on the target focus time allocation and the qualified focus time allocation, a proposed calendar entry for scheduled focus time on the online calendar associated with the target user account.

Moreover, in one or more embodiments, determining the target focus time allocation for the target user account includes receiving, from a client device associated with the target user account, a request to allocate the target focus time allocation over the specified period of time on the online calendar associated with the target user account. In some embodiments, extracting the event attributes of the scheduled event includes extracting one or more of a title, description, candidate participants, or metadata associated with a respective calendar entry corresponding to the scheduled event on the online calendar associated with the target user account.

Furthermore, in some embodiments, the series of acts 900 further includes determining, based on the qualified focus time allocation and the proposed calendar entry, a remaining focus time allocation of the target focus time allocation for the specified period of time and generating, based on the remaining focus time allocation, the qualified focus time allocation, and the proposed calendar entry, at least one additional proposed calendar entry for additional scheduled focus time on the online calendar associated with the target user account.

Additionally, in one or more embodiments, the series of acts 900 further includes identifying one or more additional scheduled events within the specified period of time on the online calendar associated with the target user account and generating the proposed calendar entry based on the one or more additional scheduled events on the online calendar associated with the target user account. Also, in some embodiments, the series of acts 900 further includes determining, from the online calendar associated with the target user account, a remaining unscheduled time allocation for the target user account and, in response to determining that the target focus time allocation is greater than or equal to the remaining unscheduled time allocation, generating the proposed calendar entry to reserve the remaining unscheduled time allocation for the scheduled focus time on the online calendar associated with the target user account. Additionally or alternatively, in some embodiments, the series of acts 900 further includes determining whether each of the one or more additional scheduled events constitutes an additional qualified focus time event and generating, in response to determining a previously scheduled event of the one or more additional scheduled events does not qualify as an additional qualified focus time event, the proposed calendar entry to replace the previously scheduled event with the scheduled focus time.

To further illustrate, in one or more embodiments, the series of acts 900 includes determining, for a target user account of an event synchronization system, a target focus time allocation over a specified period of time, identifying a scheduled event on an online calendar associated with the target user account as a qualified focus time event based on event attributes of the scheduled event, determining a qualified focus time allocation from the qualified focus time event, and generating, based on the target focus time allocation, the qualified focus time allocation, and one or more additional scheduled events on the online calendar associated with the target user account, at least one proposed calendar entry for scheduled focus time on the online calendar associated with the target user account.

Moreover, in some embodiments, the series of acts 900 further includes generating the at least one proposed calendar entry further based on corresponding event priority scores for the one or more additional scheduled events. Also, in some embodiments, the series of acts 900 further includes generating the at least one proposed calendar entry utilizing a multimodal object synchronization model to analyze the target focus time allocation, the qualified focus time allocation, and the corresponding event priority scores for the one or more additional scheduled events. Further, in one or more embodiments, identifying the scheduled event on the online calendar associated with the target user account as the qualified focus time event includes selecting the scheduled event from a plurality of candidate calendar entries of the online calendar associated with the target user account.

Also, in one or more embodiments, the series of acts 900 further includes providing, for display on a client device associated with the target user account, the plurality of candidate calendar entries of the online calendar for user selection of the qualified focus time event from the plurality of candidate calendar entries. In some embodiments, generating the at least one proposed calendar entry includes providing, for display on a client device associated with the target user account, a suggestion for cancellation of a previously scheduled event of the one or more additional scheduled events on the online calendar associated with the target user account.

Additionally, in some embodiments, the series of acts 900 further includes determining the target focus time allocation for the specified period of time based on a completed focus time allocation from a prior period of time. Also, in one or more embodiments, determining the target focus time allocation for the specified period of time includes deducting the completed focus time allocation from the prior period of time from a total periodic focus time allocation specified for the target user account.

In one or more embodiments, the series of acts 900 further includes receiving a selection of the specified period of time as a daily recurrence, a weekly recurrence, or a monthly recurrence. Also, in some embodiments, the series of acts 900 further includes generating the at least one proposed calendar entry on the online calendar across multiple recurrences of the specified period of time. In some embodiments, the series of acts 900 further includes extract the event attributes of the scheduled event from metadata provided by the online calendar associated with the target user account. In one or more embodiments, the series of acts 900 further includes determining a remaining focus time allocation of the target focus time allocation for the specified period of time and restricting subsequent calendar entries to the online calendar within the specified period of time based on the remaining focus time allocation.

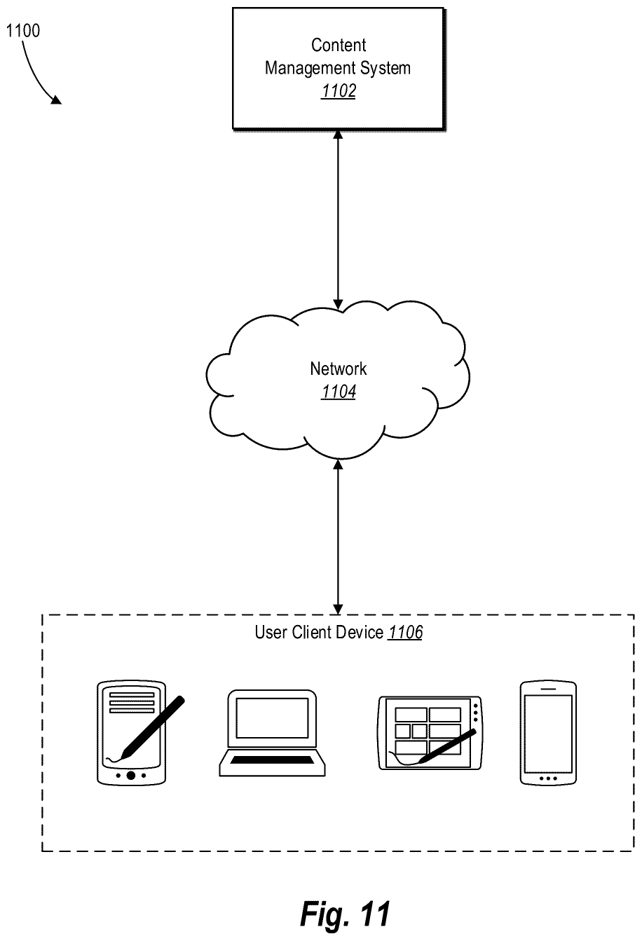

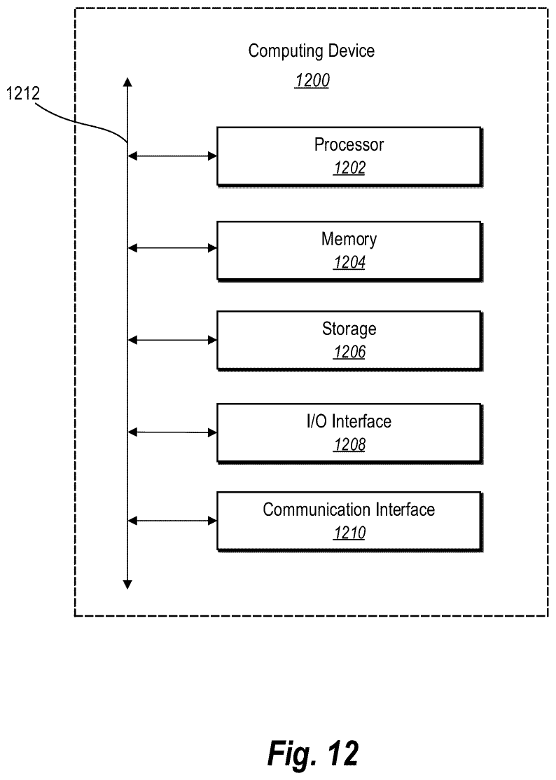

FIG. 10 illustrates a schematic diagram of an example system environment for implementing the event synchronization system 100 in accordance with one or more implementations. As shown, the system environment 1000 includes server(s) 1002, a client device 1010, third-party server(s) 1006, and a network 1014. Each of the components of the system environment 1000 can communicate via the network 1014, and the network 1014 may be any suitable network over which computing devices can communicate. Example networks are discussed in more detail below in relation to FIGS. 11-12.

As mentioned above, the example system environment 1000 includes a client device 1010. The client device 1010 can be one of a variety of computing devices, including a smartphone, a tablet, a smart television, a desktop computer, a laptop computer, a virtual reality device, an augmented reality device, or another computing device as described in relation to FIGS. 11-12. The client device 1010 can communicate with the server(s) 1002 via the network 1014. For example, the client device 1010 can receive user input from a user interacting with the client device 1010 (e.g., via the client application 1012) to, for instance, request and/or modify calendar entries for collaborative events and/or allocated focus time. In addition, the event synchronization system 100 on the server(s) 1002 can receive information relating to various interactions with graphical user interface elements based on the input received by the client device 1010 (e.g., to accept or reject a proposed calendar entry or select a proposed calendar entry from a list of optional entries).

As shown, the client device 1010 can include a client application 1012. In particular, the client application 1012 may be a web application, a native application installed on the client device 1010 (e.g., a mobile application, a desktop application, etc.), or a cloud-based application where all or part of the functionality is performed by the server(s) 1002. Based on instructions from the client application 1012, the client device 1010 can present or display information, including calendar entries, historical information, user selections and settings, focus time allocations, and so forth.

As illustrated in FIG. 10, the example environment also includes the server(s) 1002. The server(s) 1002 may generate, track, store, process, receive, search, and transmit electronic data, such as calendar objects (e.g., corresponding to scheduled events) from user-specific calendars, historical information, and so forth. For example, the server(s) 1002 may receive data from the client device 1010 in the form of requesting to schedule a collaborative event or allocated focus time, modifying user or organizational preferences, or accepting/rejecting a proposed calendar entry. In addition, the server(s) 1002 can transmit data to the client device 1010 in the form of a graphical user interface that includes a window, tab, and/or input field for initiating, requesting, or adjusting user preferences or requested events and allocations. Indeed, the server(s) 1002 can communicate with the client device 1010 to send and/or receive data via the network 1014. In some implementations, the server(s) 1002 comprise(s) a distributed server where the server(s) 1002 include(s) a number of server devices distributed across the network 1014 and located in different physical locations. The server(s) 1002 can comprise one or more content servers, application servers, communication servers, web-hosting servers, machine learning server, and other types of servers.

As shown in FIG. 10, the server(s) 1002 can also include the event synchronization system 100 as part of a content management system 1004. The content management system 1004 can communicate with the client device 1010 to perform various functions associated with generating and/or modifying proposed calendar entries and/or focus time allocations. Indeed, the content management system 1004 can include a network-based smart cloud storage system to manage, store, synchronize, version and maintain versions of one or more data objects, one or more target objects, and/or object updates associated with user accounts within the content management system (or centralized object synchronization platform) and link the content management system 1004 to third-party applications external to the content management system 1004 that are connected to the content management system via one or more software connectors. In some embodiments, event synchronization system 100 and/or the content management system 1004 utilize a database (e.g., structured object database) to store source content items, target objects, data objects, object updates, designated object versions, and/or designated object version identifiers.

FIG. 10 further illustrates one or more third-party server(s) 1006. In particular, the third-party server(s) 1006 can host or house a third-party application 1018 that includes or that searches or modifies (as part of its native application functions) one or more user-specific calendars. For example, the third-party server(s) 1006 can include a server location hosting the third-party application 1018 that is external to the event synchronization system 100 and the content management system 1004. In some cases, the third-party server(s) 1006 is external to the event synchronization system 100, but the event synchronization system 100 can nevertheless access the third-party application 1018 via one or more, connectors, plugins, APIs, or other network-based access protocols.

Although FIG. 10 depicts the event synchronization system 100 located on the server(s) 1002, in some implementations, the event synchronization system 100 may be implemented by (e.g., located entirely or in part on) one or more other components of the environment. For example, the event synchronization system 100 may be implemented by the client device 1010 and/or a third-party device. For example, the client device 1010 can download all or part of the event synchronization system 100 for implementation independent of, or together with, the server(s) 1002.

In some implementations, though not illustrated in FIG. 10, the environment may have a different arrangement of components and/or may have a different number or set of components altogether. For example, the client device 1010 may communicate directly with the event synchronization system 100 bypassing the network 1014. As another example, the environment can include the database 1008 located external to the server(s) 1002 (e.g., in communication via the network 1014) or located on the server(s) 1002, on a third-party server(s) 1006, and/or on the client device 1010.

In one or more implementations, each of the components of the event synchronization system 100 are in communication with one another using any suitable communication technologies. Additionally, the components of the event synchronization system 100 can be in communication with one or more other devices including one or more client devices described above. It will be recognized that in as much the event synchronization system 100 is shown to be separate in the above description, any of the subcomponents may be combined into fewer components, such as into a single component, or divided into more components as may serve a particular implementation.

FIG. 11 is a schematic diagram illustrating environment 1100 within which one or more implementations of the event synchronization system 100 can be implemented. As discussed above with respect to FIG. 10, in some embodiments, the event synchronization system 100 can be part of a content management system 1102. In one or more embodiments, the content management system 1102 may generate, store, manage, receive, and send digital content (such as digital videos). For example, content management system 1102 may send and receive digital content to and from the user client device 1106 by way of network 1104. In particular, the content management system 1102 can store and manage a collection of digital content. The content management system 1102 can manage the sharing of digital content between computing devices associated with a plurality of users. For instance, the content management system 1102 can facilitate a user sharing a digital content with another user of content management system 1102.

In particular, the content management system 1102 can manage synchronizing digital content across multiple of the user client device 1106 associated with one or more users. For example, a user may edit digital content using user client device 1106. The content management system 1102 can cause user client device 1106 to send the edited digital content to content management system 1102. Content management system 1102 then synchronizes the edited digital content on one or more additional computing devices.

In addition to synchronizing digital content across multiple devices, one or more implementations of content management system 1102 can provide an efficient storage option for users that have large collections of digital content. For example, content management system 1102 can store a collection of digital content on content management system 1102, while the user client device 1106 only stores reduced-sized versions of the digital content. A user can navigate and browse the reduced-sized versions (e.g., a thumbnail of a digital image) of the digital content on user client device 1106. In particular, one way in which a user can experience digital content is to browse the reduced-sized versions of the digital content on user client device 1106.

Another way in which a user can experience digital content is to select a reduced-size version of digital content to request the full-or high-resolution version of digital content from content management system 1102. In particular, upon a user selecting a reduced-sized version of digital content, user client device 1106 sends a request to content management system 1102 requesting the digital content associated with the reduced-sized version of the digital content. Content management system 1102 can respond to the request by sending the digital content to user client device 1106. User client device 1106, upon receiving the digital content, can then present the digital content to the user. In this way, a user can have access to large collections of digital content while minimizing the number of resources used on user client device 1106.

User client device 1106 may be a desktop computer, a laptop computer, a tablet computer, a personal digital assistant (PDA), an in-or out-of-car navigation system, a handheld device, a smart phone or other cellular or mobile phone, or a mobile gaming device, other mobile device, or other suitable computing devices. User client device 1106 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.), to access and view content over network 1104.

Network 1104 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which user client devices 1106 may access content management system 1102.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

FIG. 12 illustrates a block diagram of exemplary computing device 1200 that may be configured to perform one or more of the processes described above. The components of the event synchronization system 100 can include software, hardware, or both. For example, the components of the event synchronization system 100 can include one or more instructions stored on a computer-readable storage medium and executable by processors of one or more computing devices (e.g., the computing device 1200). When executed by the one or more processors, the computer-executable instructions of the event synchronization system 100 can cause the computing device 1200 to perform the methods described herein. Alternatively, the components of the event synchronization system 100 can comprise hardware, such as a special purpose processing device to perform a certain function or group of functions. Additionally, or alternatively, the components of the event synchronization system 100 can include a combination of computer-executable instructions and hardware.

Furthermore, the components of the event synchronization system 100 performing the functions described herein may, for example, be implemented as part of a stand-alone application, as a module of an application, as a plug-in for applications including content management applications, as a library function or functions that may be called by other applications, and/or as a cloud-computing model. Thus, the components of the event synchronization system 100 may be implemented as part of a stand-alone application on a personal computing device or a mobile device.

Implementations of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

As mentioned, FIG. 12 illustrates a block diagram of exemplary computing device 1200 that may be configured to perform one or more of the processes described above. One will appreciate that third-party server(s) 1006, the client device 1010, and/or the computing device 1200 may comprise one or more computing devices such as computing device 1200. As shown by FIG. 12, computing device 1200 can comprise processor 1202, memory 1204, a storage device, a I/O interface, and communication interface 1210, which may be communicatively coupled by way of communication infrastructure 1212. While an exemplary computing device 1200 is shown in FIG. 12, the components illustrated in FIG. 12 are not intended to be limiting. Additional or alternative components may be used in other implementations. Furthermore, in certain implementations, computing device 1200 can include fewer components than those shown in FIG. 12. Components of computing device 1200 shown in FIG. 12 will now be described in additional detail.

In particular implementations, processor 1202 includes hardware for executing instructions, such as those making up a computer program. As an example, and not by way of limitation, to execute instructions, processor 1202 may retrieve (or fetch) the instructions from an internal register, an internal cache, memory 1204, or storage device 1206 and decode and execute them. In particular implementations, processor 1202 may include one or more internal caches for data, instructions, or addresses. As an example, and not by way of limitation, processor 1202 may include one or more instruction caches, one or more data caches, and one or more translation lookaside buffers (TLBs). Instructions in the instruction caches may be copies of instructions in memory 1204 or storage device 1206.

Memory 1204 may be used for storing data, metadata, and programs for execution by the processor(s). Memory 1204 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. Memory 1204 may be internal or distributed memory.

Storage device 1206 includes storage for storing data or instructions. As an example, and not by way of limitation, storage device 1206 can comprise a non-transitory storage medium described above. Storage device 1206 may include a hard disk drive (HDD), a floppy disk drive, flash memory, an optical disc, a magneto-optical disc, magnetic tape, or a Universal Serial Bus (USB) drive or a combination of two or more of these. Storage device 1206 may include removable or non-removable (or fixed) media, where appropriate. Storage device 1206 may be internal or external to computing device 1200. In particular implementations, storage device 1206 is non-volatile, solid-state memory. In other implementations, Storage device 1206 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1208 allows a user to provide input to, receive output from, and otherwise transfer data to and receive data from computing device 1200. I/O interface 1208 may include a mouse, a keypad or a keyboard, a touch screen, a camera, an optical scanner, network interface, modem, other known I/O devices or a combination of such I/O interfaces. I/O interface 1208 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 1208 is configured to provide graphical data to a display for presentation to a user. The graphical data may be representative of one or more graphical interfaces and/or any other graphical content as may serve a particular implementation.

Communication interface 1210 can include hardware, software, or both. In any event, communication interface 1210 can provide one or more interfaces for communication (such as, for example, packet-based communication) between computing device 1200 and one or more other computing devices or networks. As an example and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 1210 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1210 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1210 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1212 may include hardware, software, or both that couples components of computing device 1200 to each other. As an example and not by way of limitation, communication infrastructure 1212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving a request to schedule a collaborative event with multiple candidate participants within a specified time frame;
determining attendance priority classifications for the multiple candidate participants;
identifying scheduled events on user-specific calendars of the multiple candidate participants;
determining corresponding event priority scores for the scheduled events on the user-specific calendars of the multiple candidate participants; and
generating at least one proposed calendar entry for the collaborative event based on the attendance priority classifications, the corresponding event priority scores for the scheduled events, and an event priority score for the collaborative event.

2. The computer-implemented method of claim 1, wherein determining the attendance priority classifications for the multiple candidate participants comprises identifying a priority ranking of the multiple candidate participants for the collaborative event.

3. The computer-implemented method of claim 1, wherein generating the at least one proposed calendar entry for the collaborative event is further based on a selected threshold number of required participants for the collaborative event.

4. The computer-implemented method of claim 1, wherein determining the corresponding event priority scores for the scheduled events on the user-specific calendars of the multiple candidate participants comprises extracting and comparing event attributes across the scheduled events and to determine the corresponding event priority scores relative to the collaborative event.

5. The computer-implemented method of claim 1, wherein generating the at least one proposed calendar entry for the collaborative event is further based on selected preferences comprising one or more of organization-specific work hours, attendee-specific work hours, schedule restrictions, or time-zone related adjustments.

6. The computer-implemented method of claim 1, wherein generating the at least one proposed calendar entry for the collaborative event is further based on historical information comprising one or more of prior acceptances of proposed calendar entries, prior participant attendance of scheduled events, occurrences of event rescheduling, or occurrences of canceled events.

7. The computer-implemented method of claim 1, wherein generating the at least one proposed calendar entry for the collaborative event comprises:
generating multiple alternative proposed calendar entries based on the attendance priority classifications, the corresponding event priority scores for the scheduled events, and an event priority score for the collaborative event; and
providing, for display on a client device associated with the request to schedule the collaborative event, the multiple alternative proposed calendar entries.

8. The computer-implemented method of claim 7, further comprising:
receiving, via the client device associated with the request to schedule the collaborative event, a user selection of a selected calendar entry from the multiple alternative proposed calendar entries; and
in response to receiving the user selection, proposing the selected calendar entry on each of the user-specific calendars of the multiple candidate participants.

9. A system comprising:
at least one processor; and
a non-transitory computer readable medium comprising instructions that, when executed by the at least one processor, cause the system to:
receive a request to schedule a collaborative event with multiple candidate participants, the request including attendance priority classifications for the multiple candidate participants;
identify scheduled events on user-specific calendars of the multiple candidate participants and corresponding event priority scores for the scheduled events; and
generate at least one proposed calendar entry for the collaborative event based on the attendance priority classifications, the corresponding event priority scores for the scheduled events, and an event priority score for the collaborative event.

10. The system of claim 9, further comprising instructions that, when executed by the at least one processor, cause the system to identify the scheduled events on the user-specific calendars of the multiple candidate participants across a plurality of different calendaring platforms.

11. The system of claim 10, further comprising instructions that, when executed by the at least one processor, cause the system to identify the corresponding event priority scores by comparing respective event attributes extracted from the user-specific calendars across the plurality of different calendaring platforms.

12. The system of claim 9, further comprising instructions that, when executed by the at least one processor, cause the system to generate the at least one proposed calendar entry further based on selected preferences and historical data associated with prior collaborative events.

13. The system of claim 9, further comprising instructions that, when executed by the at least one processor, cause the system to generate the at least one proposed calendar entry by utilizing a multimodal object synchronization model to analyze the attendance priority classifications, the corresponding event priority scores for the scheduled events, and an event priority score for the collaborative event.

14. The system of claim 13, wherein utilizing the multimodal object synchronization model to generate the at least one proposed calendar entry further comprises:
generating a plurality of candidate calendar entries based on the attendance priority classifications, the corresponding event priority scores for the scheduled events, and an event priority score for the collaborative event; and
comparing the plurality of candidate calendar entries to generate the at least one proposed calendar entry.

15. A non-transitory computer-readable medium comprising instructions that, when executed by at least one processor, cause the at least one processor to:
receive a request to schedule a collaborative event with multiple candidate participants within a specified time frame;
determine attendance priority classifications for the multiple candidate participants;
identify scheduled events on user-specific calendars of the multiple candidate participants and corresponding event priority scores for the scheduled events; and
generate at least one proposed calendar entry for the collaborative event based on the attendance priority classifications, the corresponding event priority scores for the scheduled events, and an event priority score for the collaborative event.

16. The non-transitory computer-readable medium of claim 15, further comprising instructions that, when executed by the at least one processor, cause the at least one processor to receive the request to schedule the collaborative event for a series of recurrent collaborative events.

17. The non-transitory computer-readable medium of claim 16, further comprising instructions that, when executed by the at least one processor, cause the at least one processor to determine the specified time frame for scheduling the collaborative event based on a selected period of recurrence and a threshold minimum time between recurrent events.

18. The non-transitory computer-readable medium of claim 16, further comprising instructions that, when executed by the at least one processor, cause the at least one processor to identify the multiple candidate participants for the collaborative event based on a listing of candidate participants from a prior event of the series of recurrent collaborative events, the listing of candidate participants including attendees and non-attendees of the prior event.

19. The non-transitory computer-readable medium of claim 15, further comprising instructions that, when executed by the at least one processor, cause the at least one processor to determine the attendance priority classifications for the multiple candidate participants by identifying required participants and a threshold minimum number of participants for the collaborative event.

20. The non-transitory computer-readable medium of claim 15, further comprising instructions that, when executed by the at least one processor, cause the at least one processor to generate an additional proposed calendar entry in response to receiving one or more rejections of the at least one proposed calendar entry.
